(19) United States
(12) Patent Application Publication
(10) Pub. No.: US 2007/0078692 A1
(43) Pub. Date: Apr. 5, 2007

(54) System for determining the outcome of a business decision

(76) Inventor: Bhavin J. Vyas, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/239,333

(22) Filed: Sep. 30, 2005

(51) Int. Cl. G06F 17/50

(52) U.S. Cl. 705/7

(57) ABSTRACT

A method for determining an outcome of a business decision. The method may include creating a hierarchical map of a business and generating a computer simulation of the business based on the hierarchical map. The method may also include identifying an action and using the computer simulation to determine an effect that the action has on the business. The method may further include conveying the effect to a customer.

### TECHNICAL FIELD

The present disclosure relates generally to a method for evaluating decisions, and more particularly, to a method for determining the outcome of a business decision.

### BACKGROUND

When managing a business, the need to make decisions may arise. The process of making decisions may involve choosing between many different alternatives to find the most desirable solution to a problem. These choices may have widely varying outcomes, and each choice may affect the business's ability to compete in a marketplace. If the business can predict the outcome of alternatives before making its decision, then it may avoid making poor choices, and thus, may avoid wasting time, energy, and/or capital.

One method that may be used to plan and make business decisions is disclosed in U.S. Pat. No. 6,115,691 to Ulwick (“Ulwick”). Ulwick discloses a method by which a user may optimize strategic options. The method includes storing data relating to a specific process for an identified customer set, and storing data relating to metrics that predict the satisfaction of customer desired outcomes. The method also includes quantifying the degree to which each of the metrics predicts satisfaction of each of the customer desired outcomes. The method further includes defining strategic options and quantifying the degree to which each of the strategic options satisfies the customer desired outcomes. Another step involves evaluating a plurality of strategic options, thus yielding a strategic option that best satisfies the customer desired outcomes. However, the method in Ulwick does not provide a framework for the stored data, organizing it in a way that intuitively models the user's operations. Also, the method of Ulwick does not provide an indication of how each strategic option affects the business's bottom line.

The present disclosure is directed towards overcoming one or more of the problems set forth above.

### SUMMARY OF THE INVENTION

In one aspect, the present disclosure may be directed to a method for determining an outcome of a business decision. The method may include creating a hierarchical map of a business and generating a computer simulation of the business based on the hierarchical map. The method may also include identifying an action and using the computer simulation to determine an effect that the action has on the business. The method may further include conveying the effect to a customer.

In another aspect, the present disclosure may be directed to a computer system. The computer system may include a console, an input device, and a central processing unit. The central processing unit may be configured to access a computer simulation, wherein the computer simulation is based on a hierarchical map of a business. The central processing unit may also be configured to receive data relating to an action and input the data into the computer simulation, use the computer simulation to determine an effect that the action has on the business, and convey the effect to a customer.

In yet another aspect, the present disclosure may be directed to a computer readable medium for use with a computer system. The computer readable medium may include computer executable instructions for accessing a computer simulation, wherein the computer simulation is based on a hierarchical map of a business. The computer readable medium may also include computer executable instructions for receiving data relating to an action and inputting the data into the computer simulation, determining, using the computer simulation, an effect that the action has on the business, and conveying the effect to a customer.

### BRIEF DESCRIPTION OF THE DRAWINGS

FIG. 1 is a diagrammatic illustration of a system, according to an exemplary disclosed embodiment.

FIG. 2 is a diagrammatic illustration of a computer system, according to an exemplary disclosed embodiment.

FIG. 3A is a diagrammatic illustration of a portion of hierarchical map, according to an exemplary disclosed embodiment.

FIG. 3B is a diagrammatic illustration of another portion of the hierarchical map, according to an exemplary disclosed embodiment.

FIG. 4 is a flow diagram of a method, according to an exemplary disclosed embodiment.

### DETAILED DESCRIPTION

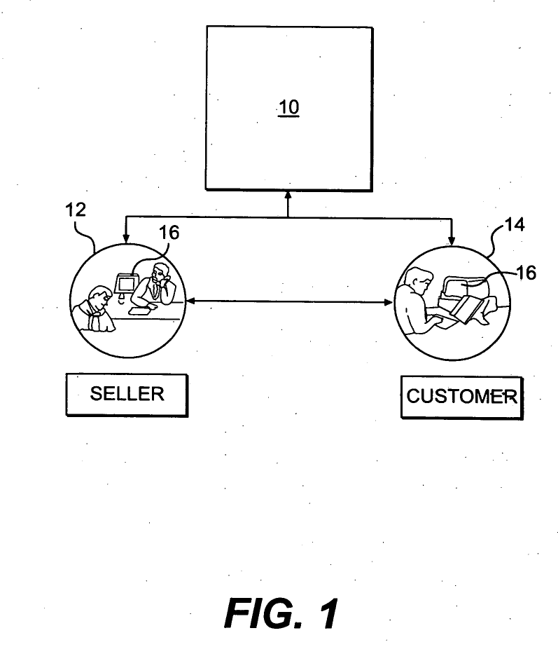

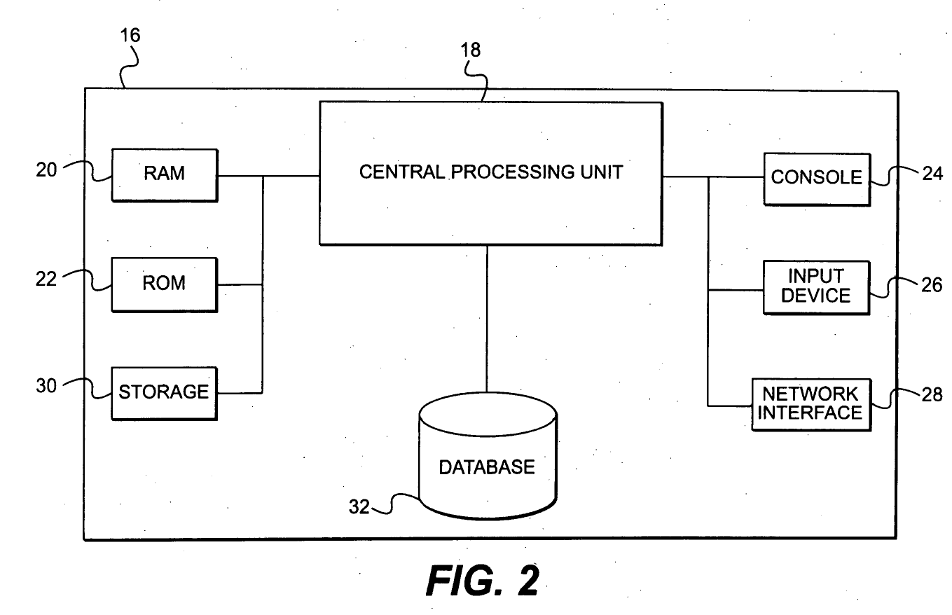

FIG. 1 illustrates a system 10 for determining the outcome of a business decision, wherein system 10 may be in operative communication with a seller 12 and a customer 14. It is contemplated that seller 12 may be a dealer, service provider, and/or business consultant. It is also contemplated that customer 14 may be an individual user or a business entity. System 10 may include one or more computer systems, with an exemplary computer system 16 being illustrated in FIG. 2. Computer system 16 may include a central processing unit (CPU) 18, a random access memory (RAM) 20, a read only memory (ROM) 22, a console 24, an input device 26, a network interface 28, a storage device 30, and at least one database 32. It is contemplated that computer system 16 may include additional, fewer, and/or different components than what is listed above. It is understood that the type and number of listed devices are exemplary only and not intended to be limiting.

CPU 18 may execute sequences of computer program instructions to perform various processes that will be explained below. The computer program instructions may be accessed and read from ROM 22, or any other suitable memory location, and loaded into RAM 20 for execution by CPU 18. Depending on the type of computer system being used, CPU 18 may include one or more printed circuit boards, and/or a microprocessor chip.

Computer system 16 may interface with a user via console 24, input device 26, and network interface 28. In particular, console 24 may provide a graphical user interface (GUI) to display information to users of computer system 16. Additionally, console 24 may include any other appropriate type of computer display device including, for example, a computer monitor, printer, or audio speaker. Input device 26 may be provided for users to input information into computer system 16, and may include, for example, a keyboard, a mouse, and/or optical or wireless computer input devices (not shown). Network interface 28 may provide communication connections such that computer system 16 may be accessible remotely through computer networks.

Storage 30 may be an appropriate type of mass storage that may store information. CPU 18 may process and access this information while performing the various processes. For example, storage 30 may include one or more hard disk devices, optical disk devices, or any other storage devices that provide data storage space.

Database 32 may contain data records about the business, such as, for example, historical data and performance data, and may also contain other information related to the data records under analysis. Database 32 may also include analysis tools for analyzing the information within database 32. CPU 18 may use database 32 to determine values relating to operations and other such pieces of information. It is further contemplated that database 32 may store one or more computer simulations and information associated with the one or more computer simulations. The computer simulations may be generated based upon one or more hierarchical maps that represent the customer's business and/or business environment.

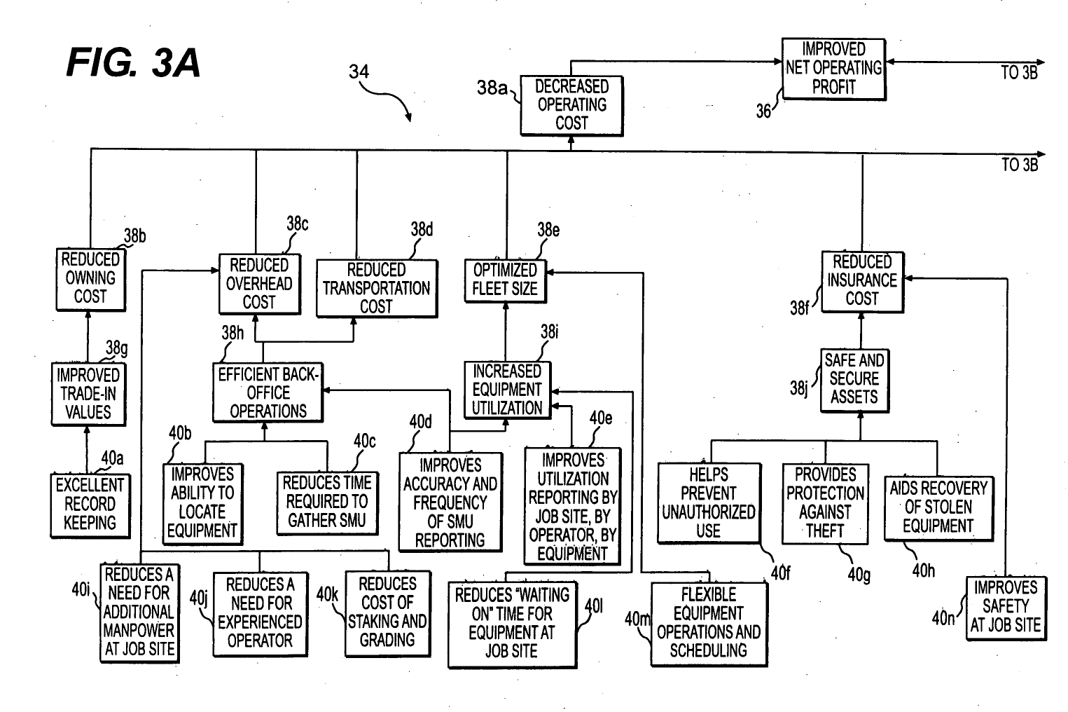

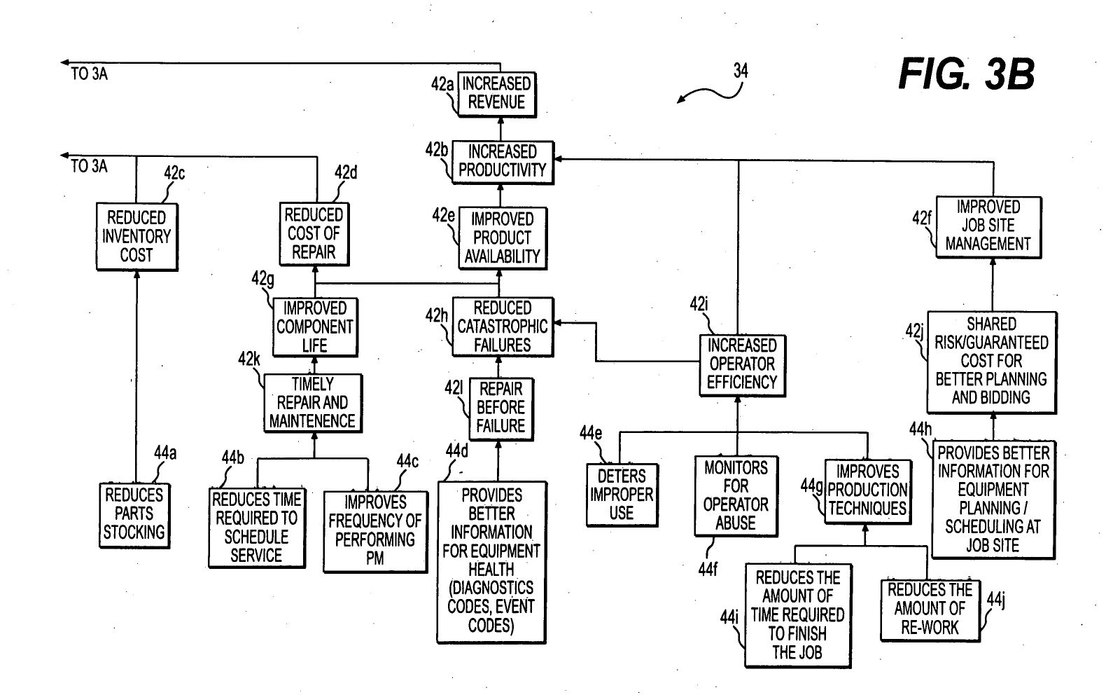

One exemplary disclosed embodiment of a hierarchical map 34 that may be used to generate computer simulations is illustrated in FIGS. 3A and 3B. Hierarchical map 34 may include an organized conceptual representation of the business, and may be created from data gathered by monitoring business operations, receiving input from the business, and/or examining historical data regarding business performance. In one disclosed embodiment, hierarchical map 34 may include one or more elements and sub-elements that define the business, its operations, and/or its environment. The elements and sub-elements may be arranged into different ranks or levels having different characteristics. The various elements, sub-elements, and levels will be further described below.

As shown in FIG. 3A, the elements and sub-elements of hierarchical map 34 may be organized into an inverted tree structure, and may include a primary objective 36, one or more secondary objectives 38a-38j, and one or more factors 40a-40n. It is contemplated that hierarchical map 34 may include a generic format allowing hierarchical map 34 to accurately represent a plurality of businesses within an industry by including those elements and sub-elements common to more than one business. Alternatively, it is further contemplated that hierarchical map 34 may be customized, by changing the nature, number, and/or arrangement of the elements and sub-elements, such that hierarchical map 34 may be applied to a specific business or a limited number of businesses. Therefore, it should be readily apparent that FIGS. 3A and 3B portray only one exemplary disclosed embodiment of hierarchical map 34, and the claimed embodiments need not be limited to the configuration shown. For example, the elements and sub-elements of hierarchical map 34 may be partially or entirely different from those shown depending on the characteristics of the particular customer, industry, and/or business environment in which hierarchical map 34 is used.

In FIG. 3A, primary objective 36 may include the highest level element from which all other elements and sub-elements depend. Primary objective 36 may represent a broad goal that customer 14 may strive to achieve. For example, customer 14 may strive to improve net operating profit, and thus, improved net operating profit may correspond to primary objective 36.

Secondary objectives 38a-38j may include elements and sub-elements that represent other goals customer 14 desires to achieve in order to satisfy primary objective 36. For example, secondary objective 38a may include decreased operating costs, which is a more narrowly defined goal than primary objective 36. If decreased operating costs may be achieved, then that may contribute towards achieving primary objective 36. Some secondary objectives, such as, for example, secondary objective 38a, may be closely related to primary objective 36. Thus, secondary objective 38 may depend directly therefrom in hierarchical map 34. Other secondary objectives, such as, for example, secondary objectives 38b-38j, may depend indirectly from primary objective 36. Those secondary objectives with the closest relationships to primary objective 36 may be of greater importance and/or greater weight than those that may depend indirectly therefrom.

Factors 40a-40n may include elements and sub-elements representing methods by which primary objective 36 and secondary objectives 38a-38j may be achieved. Alternatively, factors 40a-40n may represent benefits/advantages that could or would result from implementing solutions to remedy any problem areas in the business. Factors 40a-40n may be narrower in scope and/or more detailed than primary objective 36 and secondary objectives 38a-38j, and thus, factors 40a-40n may be arranged in the lower levels of hierarchical map 34, farthest from primary objective 36. However, it should be understood that adjusting any one of factors 40a-40n may have a resultant effect on other factors and/or secondary objectives 38a-38j. The effects may travel up the branches of hierarchical map 34, and may ultimately affect primary objective 36.

Primary objective 36, secondary objectives 38a-38j, and factors 40a-40n, may be interconnected by lines, wherein the lines may indicate that a direct relationship exists between the connected elements and sub-elements. Additionally, the lines may allow a viewer to visually determine the manner in which secondary objectives 38a-38j and factors 40a-40n affect primary objective 36 by showing relationships between those elements. Thus, hierarchical map 34 may provide a detailed representation of the business, its operations, and/or its environment.

Primary objective 36, secondary objectives 38a-38j, and factors 40a-40n will now be explained in further detail. As previously discussed, the customer's primary objective 36 may include achieving an improved net operating profit, which may be achieved by first achieving one or more secondary objectives 38a-38j. Secondary objectives 38a-38j may include the goals of decreased operating cost, reduced owning cost, reduced overhead cost, optimized fleet size, reduced insurance cost, improved trade-in values, efficient back-office operations, increased equipment utilization, and safe and secure assets, respectively. Each of these secondary objectives 38a-38j, if achieved, may contribute towards attaining primary objective 36. As previously discussed, factors 40a-40n may include methods by which primary objective 36 and secondary objectives 38a-38j may be achieved, and/or benefits/advantages gained from implementing certain solutions or actions. In one embodiment, factors 40a-40n may include excellent record keeping, improves ability to locate equipment, reduces time required to gather standard meter units (SMU), improves accuracy and frequency of SMU reporting, improves utilization reporting by job site, by operator, and/or by equipment, helps prevent unauthorized use, provides protection against theft, aids recovery of stolen equipment, reduces a need for additional manpower at job site, reduces a need for experienced operator, reduces cost of staking and grading, reduces “waiting on” time for equipment at job-site, flexible equipment operations and scheduling, and improves safety at job site, respectively. Solutions or actions may be associated with factors 40a-40n according to their resultant benefit/advantage to customer 14. While only a few factors are shown, it should be understood that other factors, including, for example, entirely different factors from those illustrated, may be employed in hierarchical map 34 so that it may accurately reflect the characteristics of different customers, businesses, and/or industries.

FIG. 3B shows another portion of hierarchical map 34, and may include secondary objectives 42a-42l. Secondary objectives 42a-42l may include increased revenue, increased productivity, reduced inventory cost, reduced cost of repair, improved produce availability, improved job site management, improved component life, reduced catastrophic failures, increased operator efficiency, shared risk/guaranteed cost for better planning and bidding, timely repair and maintenance, and repair before failure, respectively. Also shown in FIG. 3B are factors 44a-44j including, for example, reduces parts stocking, reduces time required to schedule service, improves frequency of performing parts maintenance (PM), provides better information for equipment health (diagnostics codes, event codes), deters improper use, monitors for operator abuse, improves production techniques, provides better information for equipment planning/scheduling at job site, reduces the amount of time required to finish the job, and reduces the amount of re-work, respectively. It should be understood that the structural organization of secondary objectives 42a-42l and factors 44a-44j may be similar to the structural organization of secondary objectives 38a-38j and factors 40a-40n described above. Also, while specific secondary objectives 42a-42l may be illustrated, they should not be limited only to these illustrated embodiments. Partially or entirely different secondary objectives 42a-42l may be employed in hierarchical map 34 so that it may accurately reflect the characteristics of different customers, businesses, and/or industries

Hierarchical map 34 may provide the basis for generating a computer simulation program. The computer simulation program may include computer readable instructions and/or software code written on a computer readable medium or storage device. The instructions and/or code may include one or more sets of variables and one or more sets of equations. The variables may relate to business performance measures, signals, time-related data, counters, event occurrences, and other values/measurements that may be determined by analyzing the business and/or performing calculations. The equations may include functions, algorithms, and other logic to establish relationships between the variables. The variables and equations together may mathematically define the elements, arrangements, and relationships physically represented by primary objective 36, secondary objectives 38a-38j and 42a-42l, and factors 40a-40n and 44a-44j in hierarchical map 34.

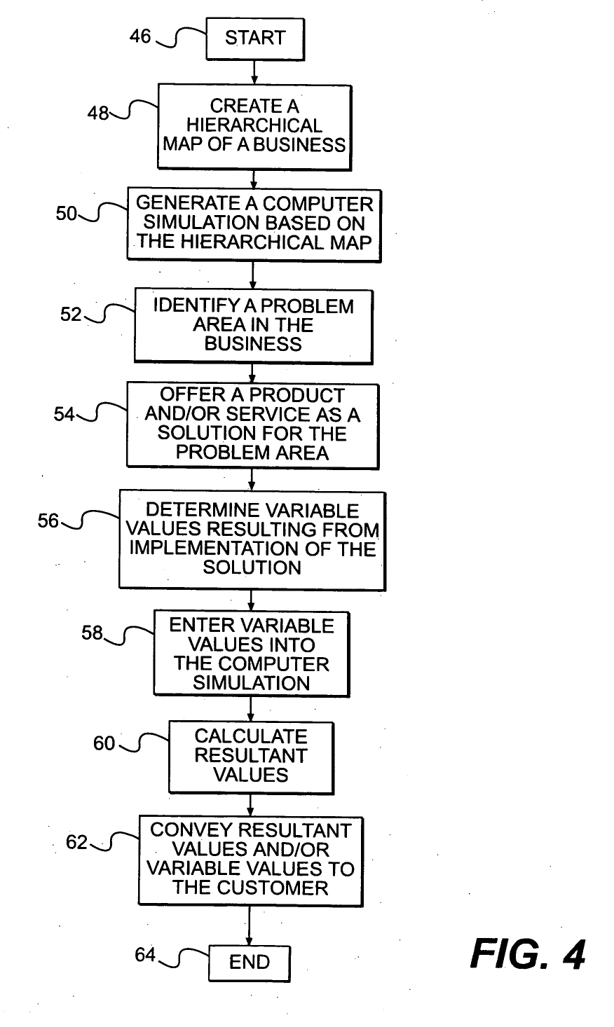

FIG. 4 illustrates a flow diagram depicting an exemplary method of using a computer simulation to determine the outcome of a business decision. The computer simulation may be stored and accessed by any suitable computing device, including, for example, computer system 16. It is also contemplated that the method may alternatively be implemented manually without the use of computer system 16. As indicated in the flow diagram, the first step after starting (step 46) may include creating hierarchical map 34 of the business (step 48). Creating hierarchical map 34 may involve collecting data and analyzing characteristics and components of the business, including, for example, business structure, assets, finances, labor, capital, performance, and related information. Afterwards, the data may be arranged into a hierarchy, exemplified by hierarchical map 34, thus creating a physical representation of the business that may provide a logical framework for further analysis by seller 12 and customer 14.

Next, the computer simulation may be generated (step 50) and may include computer readable instructions and/or software code to simulate the business using sets of variables and sets of equations to establish relationships between those variables. For example, the variables and equations may mathematically define primary objective 36, secondary objectives 38a-38j and 42a-42l, and factors 40a-40n and 44a-44j. It is contemplated that the computer simulation may be stored on a computer readable medium, a computer storage device, or may be accessible over a network.

An example of a way in which hierarchical map 34 of FIG. 3 may be converted into sets of variables and equations in the computer simulation will now be described. Factor 40n may be represented mathematically in the computer simulation using a variable “X” as an identifier. According to hierarchical map 34, factor 40n may be related to secondary objective 38f such that factor 40n may play a role in influencing secondary objective 38f. Secondary objective 38f may be represented mathematically in the computer simulation using a variable “Y” as an identifier. By analyzing the business, seller 12 may determine that the relationship between factor 40n and secondary objective 38f may be mathematically represented by the equation “Y=C₁−X,’ wherein C₁ may be a first constant or other known value.

It is also evident from hierarchical map 34 that secondary objective 38f may be related to secondary objective 38a. Secondary objective 38a may be represented mathematically in the computer simulation using a variable “Z” as an identifier. Once again, through the use of analysis, seller 12 may determine that the relationship between secondary objective 38f and secondary objective 38a may be mathematically represented by the equation “Z=C₂−Y,” wherein C₂ may be a second constant or other known value.

Secondary objective 38a may have a relationship with primary objective 36. Primary objective 36 may be represented mathematically in the computer simulation using a variable “A” as an identifier. Analysis of the business may show that the relationship between primary objective 36 and secondary objective 38a may be mathematically represented by the equation “A=(0.5)Z.” Thus, the portion of hierarchical map 34 including factor 40n, secondary objective 38f, secondary objective 38a, and primary objective 36, may be described mathematically by the following equations:

Y=C₁−X, which may mathematically characterize the relationship between factor 40n and secondary objective 38f;

Z=C₂−Y=C₂−C₁+X, which may mathematically characterize the relationship between factor 40n, secondary objective 38f, and secondary objective 38a; and

A=(0.5)Z=(0.5)(C2−C1+X)=(0.5)C2−(0.5)C1+(0.5)X, which may mathematically characterize the relationship between factor 40n, secondary objective 38f, secondary objective 38a, and primary objective 36.

The above identified equations may be translated into or otherwise entered as computer readable instructions and/or software code. In addition, the equations may be included in algorithms, including, for example, dynamic programming, linear programming, or probabilistic, genetic, or heuristic algorithms. It is contemplated that the algorithms may be embodied in a microprocessor of computer system 16, which may process information using the algorithms. The type of algorithms and the information contained therein (variables, equations, and/or other rules) may vary based on the characteristics of the business being analyzed and the type of product/service/action being implemented or proposed.

After generation of the computer simulation, the next step may include identifying problem areas in the business (step 52), as shown in FIG. 4. It should be understood that the step of identifying problem areas may also occur before, during, or immediately after any of the previously described steps. Identifying problem areas may include conducting a question and answer session and/or questionnaire where customer 14 may provide insights into aspects of the business. From the answers, seller 12 and/or customer 14 may attempt to identify one or more problem areas, or areas in which improvement may be desirable. Additionally or alternatively, customer 14 may be provided with hierarchical map 34 as an aid that may give customer 14 a logical framework for analysis of the business. For example, customer 14 may identify primary objective 36 (“improved net operating profit”) in FIG. 3A as one of the main goals of the customer's business. Seller 12 and/or customer 14 may also identify excessive operating costs as a problem area (“pain point”) of the customer's business after collecting and analyzing data. Seller 12 and/or customer 14 may refer to hierarchical map 34 as a reference to determine how to address the identified pain point by decreasing operating cost. From hierarchical map 34, it may be determined that secondary objective 38a (“decreased operating cost”) may be either directly or indirectly related to secondary objectives 38b (“reduced owning cost”) and 38g (“improved trade-in values”). Seller 12 and/or customer 14 may recommend/request a solution corresponding to factor 40a (“excellent record keeping”) because hierarchical map 34 may indicate that excellent record keeping 40a may improve trade-in values 38g and reduce owning cost 38b, thus contributing towards achieving decreased operating cost 38a (previously identified as one of the customer's pain points). It should be understood that the term “solution” may include any product, service, and/or action directed towards achieving an objective. In one embodiment, the recommended/requested solution may include, for example, a software program that may monitor and record machine data to provide a detailed history of one or more of the customer's machines. When customer 14 trades in the machines, customer 14 may receive higher trade-in values because the detailed history provided by the software may provide evidence that the machines have been properly serviced and maintained. Because ownership cost may be calculated as the difference between purchase price and trade-in value, receiving higher trade-in values can reduce owning costs incurred by customer 14. Reduction in owning cost may then decrease operating cost, thus addressing the customer's pain point.

Referring to FIG. 4, with the solution having been identified, the next step may include determining variable values resulting from implementation of the solution (step 56). In one disclosed embodiment, the solution may be implemented in the customer's business, and after implementation of the solution, analysis of the customer's business may provide variable values for the variables and equations of the computer simulation of the business. Alternatively, it is also contemplated that the solution may represent a proposal only that ultimately is not implemented in the customer's business. However, variable values may still be determined by calculating and/or estimating variable values which could result upon implementation of the solution based on historical values and/or predicted values. Once variable values (e.g., business performance measures, signals, time-related data, counters, event occurrences, and other values/measurements that may be determined by analyzing the business and/or performing calculations) are determined, those variable values may be entered into the computer simulation (step 58). Computer system 16, or any other suitable computing device, may enter the variable values into the computer simulation. The computer simulation may run and perform calculations using the variable values to solve the sets of equations. As previously discussed, the sets of equations may correspond to and mathematically describe the primary objective 36, secondary objectives 38a-38j and 42a-42l, and factors 40a-40n and 44a-44j of hierarchical map 34. Thus, solutions to the sets of equations may produce resultant values for those objectives and factors (step 60). Furthermore, it is contemplated that the resultant secondary objective values, which may be at least partially determined based on the resultant factor values, may in turn be used to determine the resultant primary objective value associated with the solution.

The resultant values and/or variable values may be conveyed to customer 14 (step 62) before the end (step 64) of the process. As previously described, variable values may include the business performance measures, signals, time-related data, counters, event occurrences, and other values/measurements that may be determined by analyzing the business and/or performing calculations. The resultant values conveyed to customer 14 may quantitatively indicate to customer 14 the benefit/advantage customer 14 may receive by implementing the recommended and/or requested solution. Furthermore, by showing each of the resultant factor values, resultant secondary objective values, and resultant primary objective value, customer 14 may gain an understanding of the effect that minor changes, such as changes to factors 40a-40n and 44a-44j of hierarchical map 34 in FIG. 3, have on the primary objective 36 and secondary objectives 38a-38j and 42a-42l. Knowledge of these values may allow customer 14 to gain a better understanding of the customer's own business operations or environment and may help in identifying possible pain points or areas needing improvement.

While the example discussed above focuses on determining the effect of implementing a single solution, it should be understood that in some cases, a solution may include a plurality of solutions or actions. The effect of each of the solutions or actions may be determined using the computer simulation, and the effects of each may be conveyed separately to customer 14. This may provide customer 14 with a way in which to compare the solutions or actions. Additionally, the combined effect of implementing the plurality of solutions or actions simultaneously may be determined using the computer simulation to provide customer 14 with an indication of the overall combined effect of implementing multiple solutions. This may be achieved by entering all of the variable values for the solutions into the computer simulation prior to running the computer simulation.

### INDUSTRIAL APPLICABILITY

The disclosed method and system may be useful in determining the outcome of a decision. In one exemplary disclosed embodiment, the method and system may include using a computerized simulation to calculate resultant values associated with the implementation of products, services, and/or other recommended actions in the business operations of a customer 14. The resultant values may be conveyed to customer 14 as an aid in the decision making process.

The disclosed method and system may include computer instructions and/or software code provided on a computer readable medium, which may be packaged with the product and/or service being sold by a seller 12. Packaging the computer readable medium in this manner may provide customer 14 with a tool to determine the value gained from purchasing the product and/or service. With this knowledge, customer 14 may be encouraged to continue using the product and/or service or to purchase additional units from seller 12.

The disclosed method and system may also function as an advertising and marketing tool utilized by seller 12 to sell products and services to customer 14. For example, seller 12 may offer customer 14 new equipment geared towards remedying one or more problem areas in the customer's business. Customer 14 may be wary, at least initially, of making a monetary investment in new equipment without first understanding how purchasing the equipment will benefit the customer's business. Seller 12 may utilize the disclosed method and system to quantitatively demonstrate how purchasing the new equipment may improve the customer's net operating profit, or any other business metric. Customer 14 may be more inclined to make the investment after being provided with this quantitative measurement of the benefit. For example, the new equipment that seller 12 intends to sell may include a fleet management system that may track a fleet of work machines owned by customer 14. Implementation of the fleet management system may help to reduce excessive downtime or catastrophic failures. These benefits, and the overall effect of the fleet management system on the bottom line of the business of customer 14 may be determined and displayed to customer 14 prior to purchasing the fleet management system to increase the likelihood that customer 14 will respond favorably to the sale of the fleet management system proposed by seller 12.

The disclosed method and system may also be implemented as a consulting tool. During the decision making process, customer 14 may attempt to determine the most beneficial course of action within a pool of potential solutions. Customer 14 may use the presently disclosed system and method to run trials for each potential solution using the computer simulation. Additionally or alternatively, customer 14 may hire an expert or consultant 12 to perform the analysis and run the computer simulation to expedite the process. For each potential solution, the disclosed system and method may return a resultant value, such as, for example, a monetary value indicating improved net operating profit, a value indicative of reductions in transportation costs, or a value indicative of an improvement in record-keeping. By comparing the resultant values of each potential solution, customer 14 may select the optimal solution by selecting the solution that may provide the most desirable results.

It will be apparent to those skilled in the art that various modifications and variations can be made in the disclosed method and system without departing from the scope of the disclosure. Additionally, other embodiments of the disclosed method and system will be apparent to those skilled in the art from consideration of the specification. It is intended that the specification and examples be considered as exemplary only, with a true scope of the disclosure being indicated by the following claims and their equivalents.

1. A method for determining an outcome of a business decision, the method comprising:
creating a hierarchical map of a business and generating a computer simulation of the business based on the hierarchical map;
identifying an action; and
using the computer simulation to determine an effect that the action has on the business.

2. The method of claim 1, wherein the hierarchical map further includes a plurality of elements and shows relationships between the elements.

3. The method of claim 2, wherein the computer simulation further includes one or more sets of variables and equations that mathematically define the relationships.

4. The method of claim 3, further including calculating resultant values for the one or more sets of variables and equations.

5. The method of claim 4, further including conveying the resultant values to a customer.

6. The method of claim 1, wherein identifying an action further includes identifying a plurality of actions.

7. The method of claim 6, further including conveying to a customer an effect of each of the plurality of actions individually.

8. The method of claim 6, further including conveying to a customer a combined effect based on the plurality of actions.

9. A computer system, comprising:
a console;
an input device; and
a central processing unit configured to:
access a computer simulation, wherein the computer simulation is based on a hierarchical map of a business;
receive data relating to an action and input the data into the computer simulation;
use the computer simulation to determine an effect that the action has on the business; and
convey the effect to a customer.

10. The computer system of claim 9, wherein the hierarchical map further includes a plurality of elements and shows relationships between the plurality of elements.

11. The computer system of claim 10, wherein the computer simulation further includes one or more sets of variables and equations that mathematically define the relationships.

12. The computer system of claim 9, wherein the action further includes a plurality of actions.

13. The computer system of claim 12, wherein the central processing unit is further configured to convey to the customer an effect of each of the plurality of actions individually.

14. The computer system of claim 12, wherein the central processing unit is further configured to convey to the customer a combined effect of the plurality of actions.

15. A computer readable medium for use with a computer system, the computer readable medium having computer executable instructions for:
accessing a computer simulation, wherein the computer simulation is based on a hierarchical map of a business;
receiving data relating to an action and inputting the data into the computer simulation;
determining, using the computer simulation, an effect that the action has on the business; and
conveying the effect to a customer.

16. The computer readable medium of claim 15, wherein the hierarchical map further includes a plurality of elements and shows relationships between the plurality of elements.

17. The computer readable medium of claim 16, wherein the computer simulation further includes one or more sets of variables and equations that mathematically define the relationships.

18. The computer readable medium of claim 15, wherein the action further includes a plurality of actions.

19. The computer readable medium of claim 18, further including instructions for conveying to the customer an effect of each of the plurality of actions individually.

20. The computer readable medium of claim 18, further including instructions for conveying to the customer a combined effect of the plurality of actions.

21. The computer readable medium of claim 15, wherein the computer readable medium is packaged with at least one of a product and service offered by a seller.

22. The method of claim 1, further including conveying the effect to a customer.
